(19) United States
(12) Patent Application Publication
(10) Pub. No.: US 2024/0202626 A1
(43) Pub. Date: Jun. 20, 2024

(54) SYSTEM FOR CREATING PRODUCTION PLAN AND METHOD THEREOF

(71) Applicant: Hitachi, Ltd., Tokyo (JP)

(72) Inventors: Hiromi Igawa, Tokyo (JP); Motonobu Saito, Tokyo (JP)

(73) Assignee: Hitachi, Ltd., Tokyo (JP)

(21) Appl. No.: 18/555,293

(22) PCT Filed: Apr. 12, 2022
(86) PCT No.: PCT/JP2022/017597

§ 371 Date: Oct. 13, 2023

(30) Foreign Application Priority Data
Apr. 27, 2021 (JP) 2021-075452

(51) Int. Cl. G06Q 10/0631; G06Q 50/04

(52) U.S. Cl. CPC G06Q 10/06313; G06Q 50/04

(57) ABSTRACT

A system for creating a production plan includes a service management device that determines whether a request from a client or a request change is within an allowable range set in advance by a contractor company, responds to the client without communicating with a planning device of the contractor company when the request is within the allowable range, transmits the request to a production planning device when the request is out of the allowable range, and responds to the client after receiving the planning result, and a planning device that, in response to a request for planning by a route other than the service management device, estimates a number of requests from another company corresponding to a requested period, and calculates and plans, each of which having a function of taking overall consistency by synchronizing the devices each time a plan is created.

### TECHNICAL FIELD

The present invention relates to a system and method for creating a production plan, which quickly create and change a production plan involving a plurality of companies.

### BACKGROUND ART

In manufacturing industries, because manufacturing requires various parts, rather than processing all parts in-house, manufacturing outsourcing to external processors and manufacturers is used. As a result, a manufacturer in charge of final assembly process is often affected by the production plans of the external contractors.

Meanwhile, processors and manufacturers receiving manufacturing outsourcing often receive outsourcing from a plurality of clients, and it is necessary to create an overall production plan according to different delivery dates for each client.

For example, when a sales company requests an increase in the number of product deliveries due to an increase in demand, the assemblers do not only coordinate own assembly plans, but also adjust with the external processors to which the assemblers outsource manufacturing, and then respond with a delivery date response. Meanwhile, when a processor receiving manufacturing outsourcing receives the additional processing request described above, because the processor has to consider the impact on the production plan of the products ordered from the other business partners before giving a response as to whether the plan can be changed, it takes time for adjustment and it is also difficult to promptly respond with a delivery date.

To solve the problems described above, PTL 1 proposes a method of, “to reduce labor involved in outsourcing manufacturing to parts processors, when a manufacturer transmits drawing data of the parts, specifying a price offered by a processor who can process the parts and determining a contract manufacturer”.

### CITATION LIST

### Patent Literature

PTL 1: JP2019-102065A

### SUMMARY OF INVENTION

### Technical Problem

The technology disclosed in PTL 1 is a method and system for selecting, by one company, a contractor that meets conditions from among a plurality of contractors, but the impact on the production plan of the contractor who receives outsourcing from a plurality of companies is not considered.

When the contractor receives outsourcing by a route other than the above system, it is necessary to formulate a production plan that considers the relationship therebetween, which requires labor for management. For example, it is conceivable that there can be mixed occasions when a company and a contractor company send and receive orders using a service such as SaaS, and when persons in charge send and receive orders indirectly such as by e-mail or telephone. Here, it is necessary for the contractor to formulate a plan and respond with a delivery date in such a form that ensures the consistency of the results exchanged by each system.

Therefore, according to the invention, in creating a production plan of a company that manufactures products outsourced by a plurality of companies, even when there are a plurality of types of requesting means and there are requests for production plan change generated by respective means, it is quickly determined whether the plan change is possible. Means for creating a production plan that reduces labor for management by quickly determining whether the plan change is possible and ensuring consistency with the overall production plan of the contractor company each time is provided.

### Solution to Problem

In a preferred example of a system for creating a production plan of the invention, the system for creating a production plan in which a network is connected to a service management device that receives a request for planning from a client company, and refers to previously stored planning conditions and when the request of the client company meets a planning condition, transmits a response accepting a manufacturing request to the client company, and when the request of the client company does not meet the planning condition, transmits the request for planning of the contractor company to a planning device of a corresponding contractor company, and a planning device that receives, at any time, a request for planning of a first client company received from the service management device or an input created by a contractor company in response to a request for planning of a second client company, creates a production plan by considering the request for planning received from the client company and an estimated value of a request for planning from any client company with recent transaction record, and outputs the result of creating the production plan to the client company from which the request is received.

In a preferred example of a method for creating a production plan of the invention, the method for creating a production plan is characterized in that a network is connected to a service management device configured for a client company and a planning device configured for a contractor company, and

the service management device stores in advance planning conditions, which are determination values for a delivery date and a number of items for each contractor company and for each item, and whether a manufacturing request can be accepted is determined without inquiring the planning device in response to a request for planning received from the client company, the method including

a process of the service management device receiving the request for planning from the client company, referring to the previously stored planning conditions, and determining whether the request of the client company meets the planning conditions,

a process of the service management device transmitting a response to accept the manufacturing request to the client company when determining that the request from the client company meets the planning conditions, and transmitting a similar response to the planning device,

a process of the planning device reflecting the response received from the service management device in the plan, recalculating and updating the planning conditions, and transmitting the planning conditions related to the corresponding client company to the service management device,

a process of the service management device receiving the planning conditions related to the client company updated by the planning device from the planning device, and updating own planning conditions and history,

a process of the service management device transmitting the request for planning of the client company to the planning device of a corresponding contractor company, when determining that the request of the client company does not meet the planning conditions,

a process of the planning device receiving the request for planning from the client company received from the service management device, creating a production plan by considering the request for planning received from the client company and an estimated value of the request for planning from another client company with recent transaction record, and responding to the service management device with the created production planning result,

a process of the planning device recalculating and updating planning conditions of all companies that placed orders in a past set period, and transmitting planning conditions related to corresponding client company to the service management device that received the request for planning,

a process of the service management device transmitting a request for planning from the client company to the planning device of the corresponding contractor company, receiving a production planning result created by the planning device, and responding with the production planning result to the client company from which the request is originally received, and

a process of the service management device transmitting the request for planning from the client company to the planning device of the corresponding contractor company, receiving the planning conditions related to the client company updated by the planning device from the planning device, and updating own planning conditions.

### Advantageous Effects of Invention

The system for creating a production plan of the invention has an effect such that a company that receives manufacturing outsourcing from a plurality of companies is able to create a plan and respond quickly and accurately, and also save the time and effort required for plan management even when the requests from the client have different request timings and request periods. The client company also earns the effect of being able to quickly obtain a delivery date response from the contractor and quickly respond to production demand.

### BRIEF DESCRIPTION OF DRAWINGS

FIG. 1 is a diagram showing a configuration example of a system in which a service management device, a planning device, and devices of respective companies that use planning, are connected to each other in an embodiment of the invention.

FIG. 2 is a functional configuration diagram of the service management device.

FIG. 3 is a functional configuration diagram of the planning device.

FIG. 4 is a diagram showing an example of a hardware configuration of a planning device 20, plan requesting devices 30 and 40, business devices 22 and 50, and the like.

FIG. 5 is a diagram showing an example of a flow of data between a service management device, a plan planning device, and clients.

FIG. 6 is a diagram showing examples of a setting information data table, a planning condition data table, and a historical data table stored in the service management device.

FIG. 7A is a diagram showing an example of a setting information data table, a planning condition data table, and a historical data table stored in the planning device.

FIG. 7B is a diagram showing an example of a plan data table and a performance data table stored in the planning device.

FIG. 8 is an operation flowchart of a service management means of the service management device.

FIG. 9 is an operation flowchart of a plan adjustment means of the service management device.

FIG. 10 is an operation flowchart of a service synchronization means of the planning device.

FIG. 11 is an operation flowchart of a planning means of the planning device.

FIG. 12 is an operation flowchart of a plan evaluation means of the planning device.

FIG. 13 is a diagram showing an example of a screen on which the planning device reports the result of planning to a user.

### DESCRIPTION OF EMBODIMENTS

A service management device, a planning device, and a production planning method for realizing the invention will be described below with reference to the drawings.

### First Embodiment

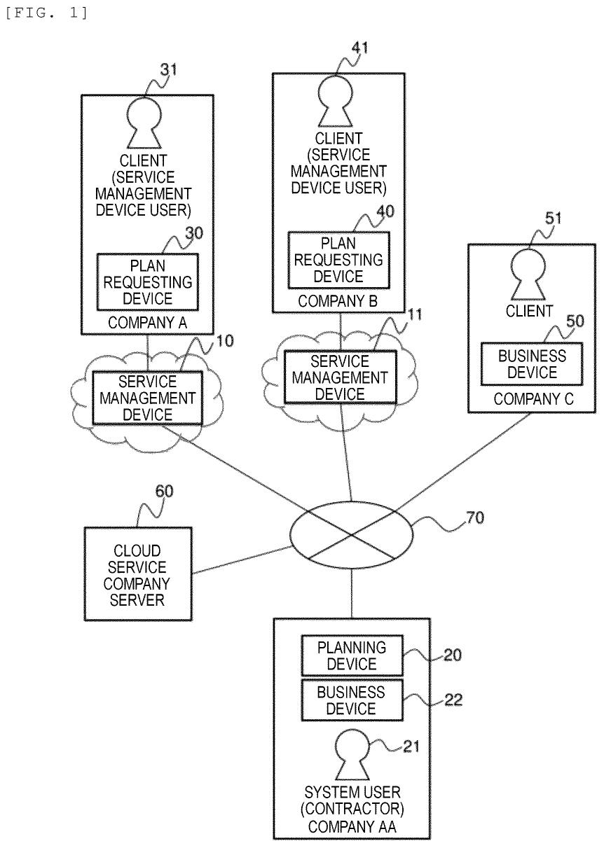

FIG. 1 shows a configuration diagram of a system in which a plurality of client companies that use service management devices provided by a cloud service company, contractor companies that use planning devices installed on own computers, and traditional contractor companies that do not use service management devices, are connected to each other by a network 70, to support the efficiency of production plan formulation, delivery date response, and the like between the companies.

A service management device 10 is for a client company 31, a service management device 11 is for a client company 41, and the devices are virtual devices provided on the cloud by the cloud service company while the actual devices reside on a cloud service company server 60.

The plan requesting devices 30 and 40 are general work devices whose specifications are modified to outsource manufacturing using the service management device.

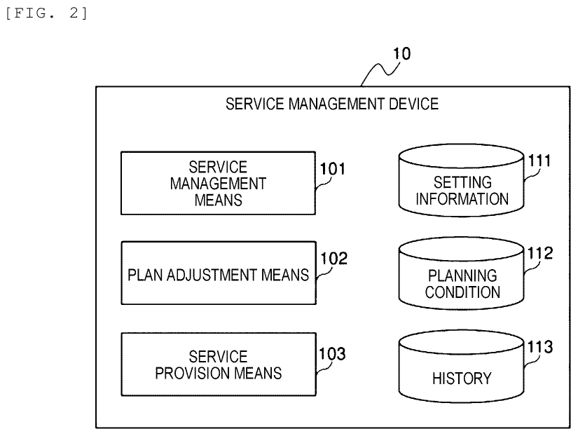

FIG. 2 shows a functional configuration diagram of the service management device 10 of the present embodiment. The functional units are roughly divided into three parts of a service management means 101, a plan adjustment means 102, and a service provision means 103. The service management means 101 transmits and receives information to and from the planning device 20 and updates setting information 111 and planning conditions 112. The plan adjustment means 102 adjusts a production plan while referring to the planning conditions 112, and updates history 113 each time the production plan is adjusted. The service provision means 103 displays a result after adjustment by the plan adjustment means 102 on the plan requesting device 30 used by the client company 31.

Although the service management device 10 is configured on the cloud in the present embodiment, the device may be configured to be installed and executed on the computer of the client company 31, for example.

The service management device 11 serves in exactly the same way as the service management device 10 with respect to the client company 41.

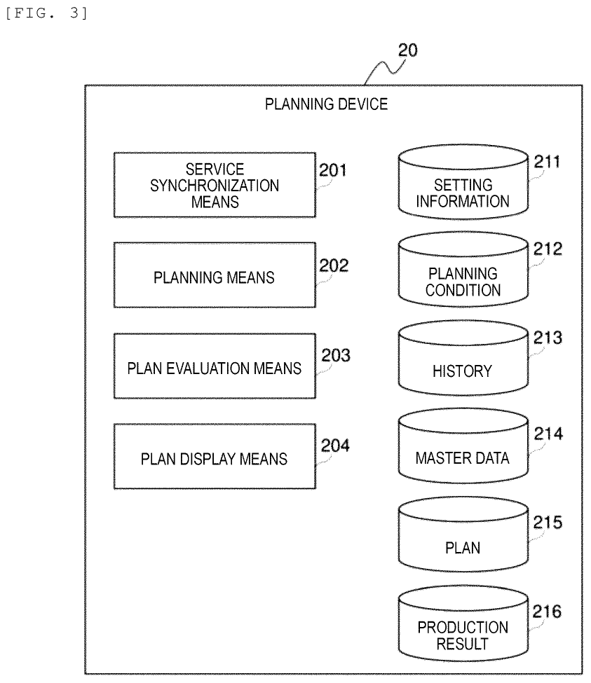

FIG. 3 shows a functional configuration diagram of the planning device 20 used by a contractor company 21 of the present embodiment. The functional units are roughly divided into four parts of a service synchronization means 201, a planning means 202, a plan evaluation means 203, and a plan display means 204.

The service synchronization means 201 stores, in setting information 211, the setting information received from the user, transmits information on planning conditions 212 to the service management means 101 of the service management device, and stores, in a plan 215, plan information received from the service management means 101.

The planning means 202 stores, in master data 214, specification information necessary for production planning received from the user, performs the production planning, and stores the result in the plan 215.

The plan evaluation means 203 refers to the plan 215 and actual production results 216 acquired from other devices such as a manufacturing unit, evaluates the plan using indicators such as the on-time delivery rate, and reflects the results in the planning conditions 212.

The plan display means 204 refers to the plan 215 and displays, to the user, planning status from a plurality of viewpoints such as by companies or by product items.

In the present embodiment, the planning device 20 is installed and executed on the computer of the contractor company 21, but the device may be provided by the cloud service company and configured on the cloud.

The planning device 20 may be configured on the same computer as the computer on which the business device 22 of the contractor company 21 is configured.

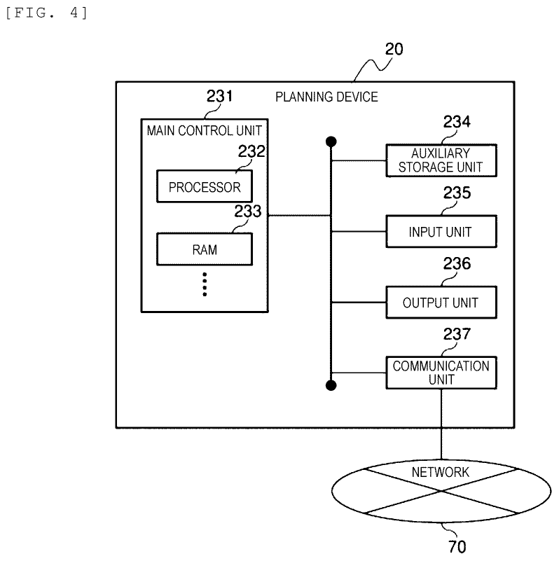

FIG. 4 is a diagram showing a hardware configuration of the planning device 20, the plan requesting devices 30 and 40, the business devices 22 and 50, and the like. Each device (exemplified by the planning device 20 in FIG. 4) includes a main control unit 231 that can be configured on a general-purpose computer and includes a processor (CPU) 232, a random access memory (RAM) 233, and the like, an auxiliary storage unit 234 including a read only memory (ROM), a hard disk drive (HDD), a solid state drive (SSD) using a flash memory, and the like, an input unit 235 including input devices such as a keyboard and a mouse, an output unit 236 including a display device such as liquid crystal display (LCD), organic EL display, various output devices, and the like, and a communication unit 237 including a network interface card (NIC), and the like.

The communication unit 237 is connected to a service management device, business devices of each company, and the like via a network 70 that is wired or wireless network.

The main control unit 231 implements each functional unit shown in FIG. 3 by loading application program for each process stored in the auxiliary storage unit 234 into the RAM 233 and executing the same by the processor (CPU) 232.

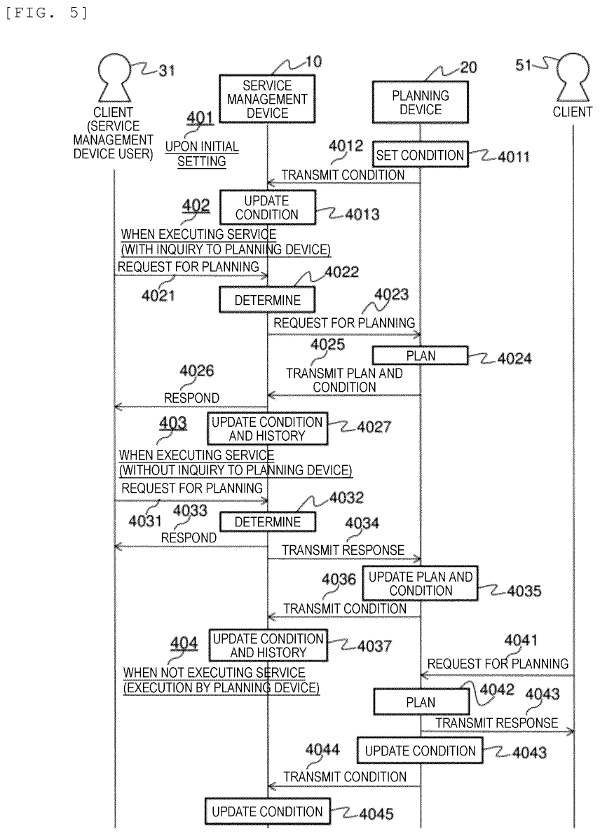

FIG. 5 shows an example of a flow of data between the service management device 10 (the same applies to the service management device 11), the planning device 20, and the client company. The operation of the planning device 20 differs between when the client company 31 creates a plan via the service management device 10 and when the contractor user 21 receives a request from the client company 51 and directly creates a plan.

First, at the time of initial setting 401 of the planning device 20, the conditions are set by receiving the input from the user 21 (4011) and stored in the setting information 211, and the client conditions managed by the service management device 10 are transmitted (4012). The service management device 10 receiving the conditions from the planning device 20 stores the received conditions in the planning conditions 112 (4013).

There are two modes of operation of the service management device 10, that is, operation with an inquiry to the planning device 20 (when executing service 402) and operation without an inquiry (when executing service 403). First, for the operation 402 with an inquiry, a request for planning (an inquiry about whether manufacturing can be outsourced) is received from the client company 31 (4021), and the service management device 10 determines whether it is possible to respond (4022). As a result of the determination, when the inquiry is required, the request information from the client company 31 is transmitted to the planning device 20, thereby making a request for planning (4023). The planning device 20 creates a plan based on the request from the service management device 10 (4024), and transmits the calculated result and the updated conditions (4025). The service management device 10 responds to the client company 31 with the received plan (4026), and similarly stores the received conditions in the planning conditions 112 (4027). Note that the service management device 10 also updates the history 113 when updating the planning conditions 112 at 4027.

Next, when the service management device 10 does not inquire the planning device 20 (403), a request for planning (inquiry about whether manufacturing can be outsourced) is received from the client company 31 (4031), and the service management device 10 determines whether it is possible to respond (4032). As a result of the determination, since it is not necessary to inquire the planning device 20, a response is transmitted to the client company 31 (4033), and a similar result is transmitted to the planning device 20 (4034). The planning device 20 reflects the received plan in the plan 215 and updates the planning conditions 212 (4035). Then, the planning device 20 transmits the updated conditions to the service management device 10 (4036). The service management device 10 stores the received conditions in the planning conditions 112 (4037). Note that the service management device 10 also updates the history 113 when updating the planning conditions 112 at 4037.

Finally, when the planning device 20 is executed without using the service management device 10 (for example, when service is not executed 404), a person in charge at the contractor company 21 indirectly receives a request for planning (inquiry about whether manufacturing can be outsourced) from the traditional client company 51 that does not use the service management device (4041), and the user 21 inputs the request to the planning device 20 so that plan is created (4042). Here, the user 21 of the planning device 20 transmits a response after planning (4043), and then the planning device 20 updates the conditions (4043). Then, the updated conditions are transmitted from the planning device 20 to the service management device (4044). The service management device 10 stores the received conditions in the planning conditions 112 (4045).

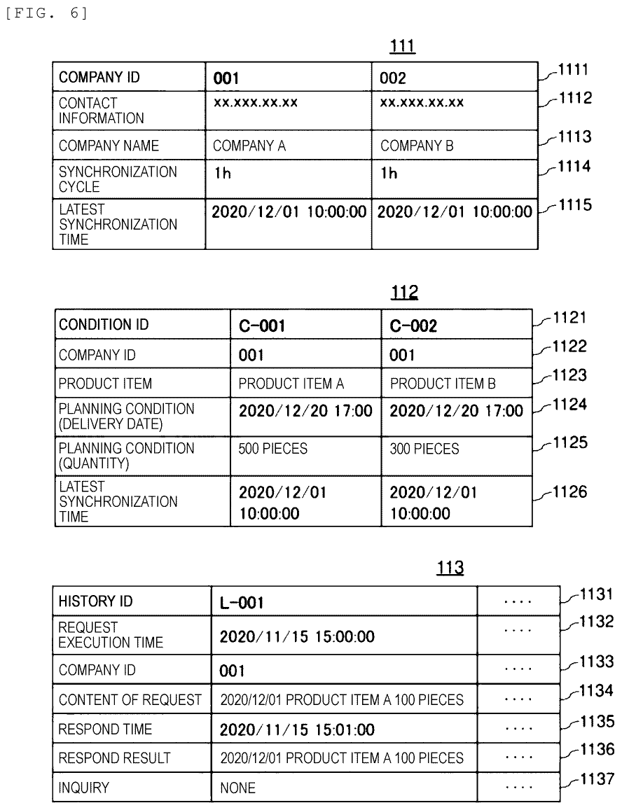

FIG. 6 shows an example of the setting information data table 111, the planning condition data table 112, and the historical data table 113 stored in the auxiliary storage unit 234 of the service management devices 10 and 11.

The setting information data table 111 includes, as data items, a company ID 1111 that can uniquely identify a company, connection destination information 1112 indicating an IP address and the like as connection information of a connection destination planning device, a company name 1113 of the company that uses the connection, a synchronization cycle 1114 with the planning device 20, and a latest synchronization time 1115. In the data table, the company ID 1111, the connection destination information 1112, the company name 1113, and the synchronization cycle 1114 are set in advance at the start of service use, and the latest synchronization time 1115 is updated each time synchronization with the planning device 20 is performed. Note that the unit of the synchronization cycle is one hour in the example shown in the drawing, but the cycle can be freely set in units of hours, minutes, weeks, or months.

The planning condition data table 112 includes, as data items, a condition ID 1121 that can uniquely identify inquiry condition of inquiry to the planning device, a company ID 1122 that can uniquely identify a company to which the condition is applied, a product item 1123 that is an automatic response condition, planning condition (delivery date) 1124, planning condition (production quantity) 1125, and latest synchronization time 1126. In the data table, the condition ID 1121, the company ID 1122, and the product item 1123 are set in advance at the start of service use, and the planning condition (delivery date) 1124, the planning condition (quantity) 1125, and the latest synchronization time 1126 are updated as the data are received from the planning device 20 or transmitted from the service management device 10. For example, regarding condition with condition ID C-001, the planning condition (delivery date) 1124 and the planning condition (quantity) are set for a request (inquiry about whether manufacturing can be outsourced) regarding a product item A from a company ID 001 (company A). The latest synchronization time 1126 is updated at the timing of updating information from the service management device 10 to the planning device 20. Meanwhile, regarding condition ID C-002, the delivery date and the quantity of product item B from company ID 001 (A company) are set.

The historical data table 113 includes, as data items, a history ID 1131 that can uniquely identify a history, a request execution time 1132 from the client company, a company ID 1133, content of request 1134 from a client company, response time 1135 of the result, a response result 1136 indicating the content of the response, and inquiry 1137 for recording whether there is an inquiry to the planning device 20. The data table is recorded when a request for planning is generated from the client company and a response is completed (4027, 4037 in FIG. 5).

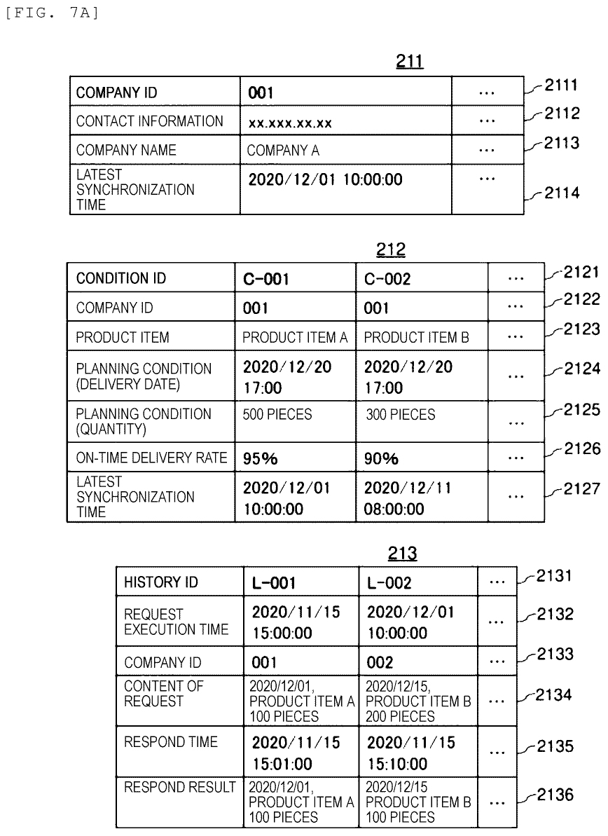

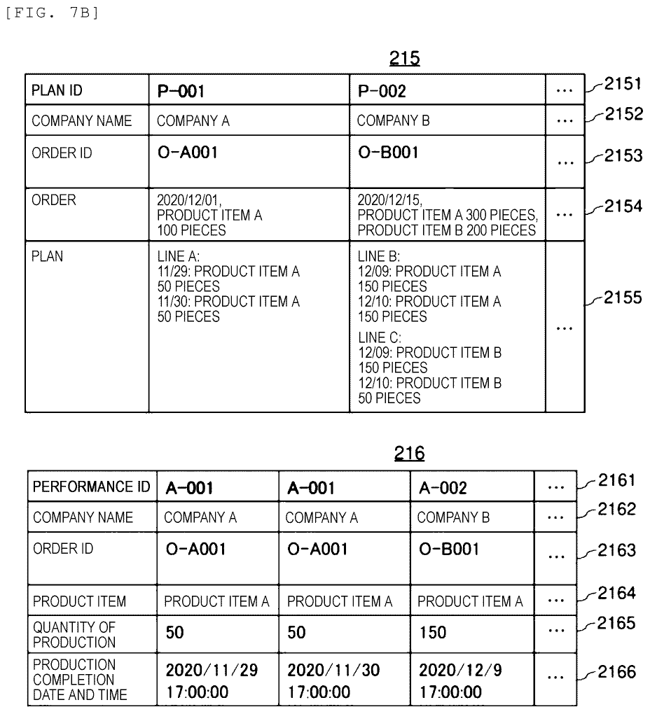

FIGS. 7A and 7B show examples of the setting information data table 211, the planning condition data table 212, the historical data table 213, the planning data table 215, and the actual production result data table 216, which are stored in the auxiliary storage unit 234 of the planning device 20.

The setting information data table 211 includes, as data items, a company ID 2111 that can uniquely identify a connection destination company, connection destination information 2112 indicating an IP address and the like as connection information of a connection destination service management device, a company name 2113 that can identify the client company that uses the connection, and a latest synchronization time 2114. In the data table, the company ID 2111, the connection destination information 2112, and the company name 2113 are set in advance at the start of service use, and the latest synchronization time 2114 is updated each time synchronization with the service management devices 10 and 11 is performed.

The planning condition data table 212 includes, as data items, a condition ID 2121 that can uniquely identify a condition managed by the service management device, a company ID 2122 that can uniquely identify a client company that the condition is applied to, a product item 2123 to be set in the service management device, a planning condition (delivery date) 2124, a planning condition (production quantity) 2125, on-time delivery rate 2126, and a latest synchronization time 2127. In the data table, the condition ID 2121, the company ID 2122, the product item 2123, the planning condition (delivery date) 2124, and the planning condition (quantity) 2125 are set in advance at the start of service use. The planning condition (delivery date) 2124 and the planning condition (quantity) 2125 are calculated and updated each time the planning device 20 creates a plan. The latest synchronization time 2127 is updated when the planning condition (delivery date) 2124, and the planning condition (quantity) 2125 are synchronized with the service management device 10. The on-time delivery rate is calculated and updated by comparing a difference with the plan 215 each time the actual production result 216 is updated.

The historical data table 213 includes, as data items, a history ID 2131 that can uniquely identify a history, a request execution time 2132 from the client company, a company ID 2133, content of request 2134 from the client company, a response time 2135 of the result, and a response result 2136 representing the content of the response. The data table is recorded when a request for planning is generated from the client company and a response is completed, and when information from the service management devices 10 and 11 is synchronized. In the content of request 2134 and the response result 2136, for example, “delivery date (2020/12/1)”, “product item (product item A)”, and “requested quantity/responded quantity (100 pieces)” are described.

The plan data table 215 includes, as data items, a plan ID 2151 that can uniquely identify the plan, a client company name 2152 of the plan, an order ID 2153 that can uniquely identify the content of request, an order 2154, and a plan 2155. The data table is created at the timing of receiving the plan from the service management devices 10 and 11, or at the timing of completion of planning upon request from the business device 22. The plan includes “line information (line A)”, “product items to be produced and quantities to be produced by day (11/29, product item A, 50 pieces, and the like)”, but other information may be included.

The actual production result data table 216 includes, as data items, a performance ID 2161 that can uniquely identify the actual production result, a client company name 2162, an order ID 2163, a product item 2164, a production quantity 2165, and a production completion date and time 2166. The data table is information acquired from a system that is connected to a device such as a manufacturing line and that can acquire the actual manufacturing result information of the manufacturing unit.

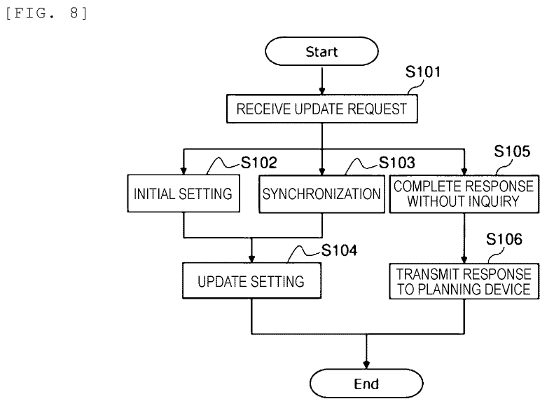

FIG. 8 shows an operation flow of the service management means 101 of the service management devices 10 and 11. The service management means 101 is activated when an update request is received, and executes a series of processes.

At step S101, when an update request is received, the operation branches according to the type of the update request. When initial setting input is received from the client company or the person in charge at the cloud service company at the start of service use, the setting information is received (S102), the setting information 111 is updated (S104), and the operation ends.

Next, when a synchronization request is received from the planning device 20 (S103), the planning conditions received from the planning device 20 are reflected in the planning conditions 212 (S104), and the operation ends.

Finally, when a response is made to the client company without inquiring the planning device 20 (S105), a report of the content of the response is transmitted to the planning device 20 (S106), and the process ends.

As described above, when a change occurs on the side of the planning device 20, information is synchronized with the transmission from the planning device 20 as a trigger, and when the process (response to the request for manufacturing outsourcing) is completed in the service management devices 10 and 11, the responded production planning information is synchronized to the planning device 20 with the response from the service management device as a trigger, so that it is possible to quickly obtain consistency of the production planning information, and even when requests for manufacturing outsourcing are generated by a plurality of means from a plurality of companies, it is possible to create a production plan and respond accurately and quickly.

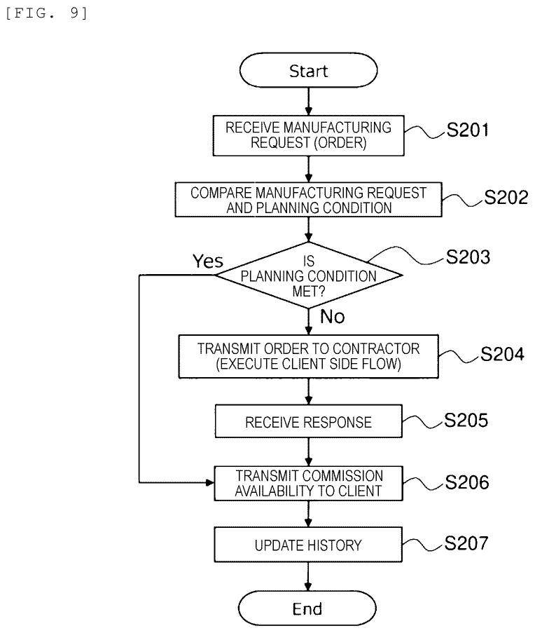

FIG. 9 shows an operation flow of the plan adjustment means 102 of the service management devices 10 and 11. The plan adjustment means 102 is activated when a manufacturing request (order) is received from the client company, and executes a series of processes.

At step S201, when a manufacturing request (order information) is received (S201), by referring to the data record of the corresponding client company and the corresponding product item in the planning condition data table 112, the delivery date and requested quantity of the manufacturing request are compared with the planning condition (delivery date) and planning conditions (quantity) of the planning condition data table 112 (S202). As a result of the comparison, when the manufacturing request meets the planning conditions 112 (when the request meets a condition that the delivery date of the manufacturing request is same or earlier than the planning condition (delivery date) and that the requested quantity of the manufacturing request is same or less than the planning condition (quantity)), the process proceeds to S206, and when the manufacturing request does not meet the planning conditions 112 (when the delivery date of the manufacturing request is later than the planning condition (delivery date), or when the requested quantity of the manufacturing request is greater than the planning conditions (number)), the process proceeds to S204 (S203).

At step S204, it is determined that the service management device cannot determine whether to accept the manufacturing request received from the client company, and the manufacturing request (order information) received from the client company is transmitted to the planning device 20.

At step S205, the process waits for completion of the planning considering the manufacturing request transmitted by the planning device 20, and receives a response from the planning device 20.

At step S206, when the manufacturing request meets the planning conditions in S203, a response that the manufacturing request can be accepted is transmitted to the client company, and when the production request does not meet the planning conditions in S203, the response received from the planning device 20 is transmitted to the client company.

At step S207, the history 113 is updated according to the content of request received in S201, the result of response in S207, and the like, and the process ends.

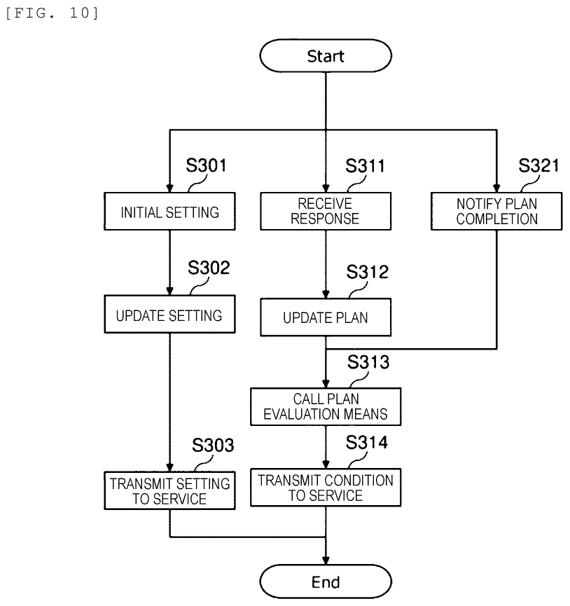

FIG. 10 shows an operation flow of the service synchronization means 201 of the planning device 20. The service synchronization means 201 is activated by a plurality of triggers and executes a series of processes.

First, in the case of initial setting (S301), when a setting request is received from a user (contractor company), the setting information 211 is updated (S302), the setting information is transmitted to the service management devices 10 and 11 (S303), and the operation ends.

Next, when the report (synchronization request) of the manufacturing request acceptance information (response information) responded to the client company is received on the service management devices 10 and 11 side (S311), the production plan (response information) received from the service management device 10 is reflected in the plan 215 (S312), and the plan evaluation means 203 is activated (S313). When the plan evaluation is completed, the updated conditions are transmitted to the service management devices 10 and 11 (S314), and the operation ends.

Finally, when the plan is directly created by the planning device 20, the completion of calculation is detected (S321), and the plan evaluation means 203 is activated (S313). When the plan evaluation is completed, the updated conditions are transmitted to the service management devices 10 and 11 (S314), and the operation ends.

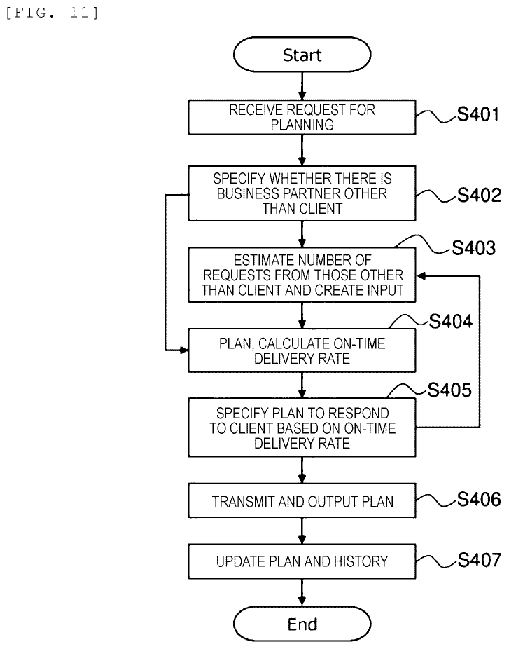

FIG. 11 shows an operation flow of the planning means 202 of the planning device 20. The planning means 202 is activated by the user when the user (contractor company) 21 of the planning device 20 receives a manufacturing request via the business device 22 and the like and creates a plan, or is activated by receiving a request from the service management devices 10 and 11 and executes a series of processes when a manufacturing request (order) from the client company does not meet conditions set in advance by the service management devices 10 and 11.

First, when the request for planning (manufacturing request) is received (S401), by referring to the planning conditions 212, whether there are business partners other than the client company from which the request is received is specified (S402). Here, a company with an old latest synchronization time (for example, there was no synchronization for three months or more) is considered to have no recent transaction and excluded.

Next, by referring to the delivery date of the content of request, when the final date and time of the request from the company other than the client is different from the delivery date, by referring to the actual production results 216, the number of requests from the company other than the client is estimated, and input data is created (S403). For example, on 2020/11/15, when there is a request for 100 pieces from company A with a delivery date of 2020 Dec. 15 which is one month later, and the final delivery date of company B is 12/1, the number of requests from company B from 12/2 to 12/15 is estimated. Note that a publicly known technique is used as a method for estimating the number of requests. After repeating the process for the companies specified in S402, a production plan is created, and an estimated value of the on-time delivery rate is calculated from the calculated production plan and the actual production results 216 (S404). Note that a publicly known technique is used for the production planning method. Then, the calculated on-time delivery rate is compared with the on-time delivery rate set in the planning condition 212, and a plan with a close on-time delivery rate is specified (S405). Then, when activated by the user, the plan is output to the user, and when activated by the service management devices 10 and 11, the plan is transmitted to the service management devices 10 and 11 (S406), the plan 215 and the history 213 are updated (S407), and the process ends.

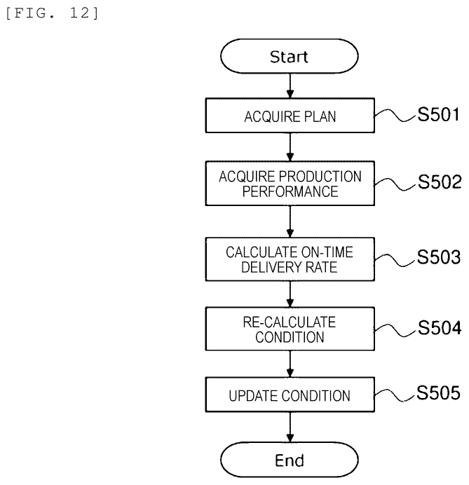

FIG. 12 shows an operation flow of the plan evaluation means 203 of the planning device 20. The plan evaluation means 203 is activated with the update of the history 213 or the update of the actual production result 216 as a trigger, and executes a series of processes related to the update of the planning conditions 212. Note that the plan evaluation means 203 may be activated periodically.

In the recalculation of the planning conditions, the planning condition (delivery date) and the planning condition (quantity) are calculated for each product item with respect to companies with transactions during a preset period, among the companies stored in the planning conditions 212. The delivery date is standardized for all companies to be calculated, and is set to a preset period (for example, one month) from the current date and time, or changed for each company and set to a preset period (for example, 1 month) from the delivery date of the latest order of each company.

First, the previous plans from the set period are acquired from the plan 215 (S501), and then the actual production results 216 for the same period are acquired retroactively from the current date and time (S502). For example, when the delivery date is one month from the current date and time, the actual production results for the past one month are acquired. Next, the on-time delivery rate is calculated from the difference between the actual production results and the plan (S503). For example, the definition of on-time delivery rate is defined as follows:

On-time delivery rate=Percentage of number of orders for which production is completed by the scheduled production completion date considering the delivery date or delivery period

Next, the service management devices 10 and 11 recalculate planning condition (quantity) that can be responded (S504). In the calculation of the planning condition (quantity) for each product item, first, the total production quantity of the corresponding product item in the set period is predicted based on the actual production result acquired at step S502. Next, the order ratio for each company is calculated from the number of orders placed by companies who placed orders during the set calculation period from the calculation start date. For example, when the number of product item A that can be manufactured in one month is 500, and the order results of companies A, B and C are 100, 300 and 100 respectively, since the order ratio is 1:3:1, the number of manufacturable units as planning conditions is 100, 300, and 100.

Next, considering the on-time delivery rate, the number of manufacturable products is adjusted so that the on-time delivery rate becomes 100%. For example, when the actual on-time delivery rates are 95%, 90%, and 100%, respectively, then, it is 95, 270, and 100, respectively. Finally, when there is already a quantity of orders received during the corresponding period, the number obtained by subtracting the quantity of orders received is set as the planning condition. For example, although the manufacturable quantity of company A is 95, when 50 orders were already received during the calculation period, the manufacturable quantity of planning conditions is set to 45.

Then, the planning conditions 212 are updated (S505), and the process ends.

By executing the process for every change of orders and results, it is possible to set appropriate planning conditions considering the latest actual production results and orders from each company.

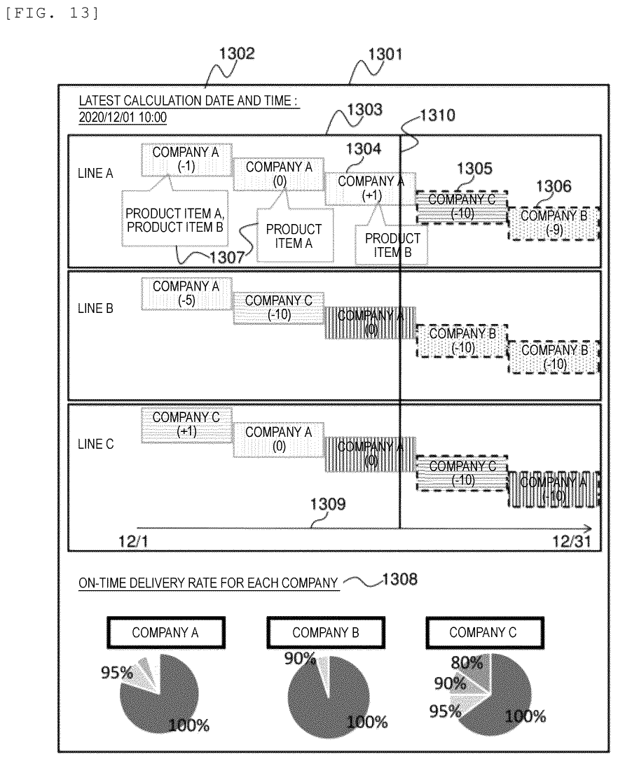

FIG. 13 shows an example of a screen on which the planning device 20 reports the results of planning to the user. A screen example 1301 shows a latest calculation execution date and time 1302, a production plan 1303 for each production line, and an on-time delivery rate 1308 for each company. A time axis 1309 and a current date and time 1310 are displayed. For example, on the screen, the left end is 12/1 and the right end is 12/31, indicating a production plan for one month.

First, the production plan 1303 for each production line shows the production plan in chronological order, and the length of each box indicates the time required for production by the same client. In each box, the client and the number of days different from the requested delivery date are indicated. In the example of line A, “company A (−1)” indicates that the request from company A will be manufactured one day earlier than the requested delivery date. In balloon 1307, in response to mouseover by the user, the name of the product item manufactured at that time is displayed. The shade of the color of the box is changed according to the planning time. For example, the color is displayed darker as the difference between the current time and the planning time decreases. This makes it easier to distinguish the request reception times for each company. The line type of the box is changed according to whether it is an estimated value. In the drawing, a solid line 1304 indicates an actually requested production plan, and dotted lines 1305 and 1306 indicate estimated production plans. By confirming such information, the user can easily check the on-time delivery rate and production order timing for each company or for each product item.

The on-time delivery rate 1308 for each company indicates the on-time delivery rate for each company within a preset period. Note that the period for calculating the on-time delivery rate can be changed, for example, by matching with the displayed planned period. The user can consider changing the set conditions based on the on-time delivery actual results.

Note that the invention is not strictly limited to the embodiments described above, and can be embodied by modifying the components without departing from the scope of the invention at the implementation stage. Various inventions can be formed by appropriately combining a plurality of components disclosed in the embodiments described above. For example, some components may be omitted from all components shown in the embodiments. Components in different embodiments may be combined as appropriate.

### REFERENCE SIGNS LIST

10, 11 service management device
20 planning device
21 contractor company
22 business device of contractor company
30, 40 plan requesting device of client company using service management device
31, 41 client company using service management device
50 business device of client company not using service management device
51 client company not using service management device
60 cloud service company server
70 network
101 service management means
102 plan adjustment means
103 service provision means
111 setting information data table
112 planning condition data table
113 historical data table
201 service synchronization means
202 planning means
203 plan evaluation means
204 plan display means
211 setting information data table
212 planning condition data table
213 historical data table
214 master data table
215 plan data table
216 actual production result data table
231 main control unit
232 processor (CPU)
233 RAM
234 auxiliary storage unit
235 input unit
236 output unit
237 communication unit
1301 screen for reporting planning result

1. A system for creating a production plan characterized in that a network is connected to:
a service management device that receives a request for planning from a client company, refers to previously stored planning conditions, transmits a response accepting a manufacturing request to the client company when the request of the client company meets planning conditions, and transmits the request for planning of the client company to a planning device of a corresponding contractor company when the request of the client company does not meet the planning condition; and
a planning device that receives, at any time, a request for planning of a first client company received from the service management device or an input created by a contractor company in response to a request for planning of a second client company, creates a production plan by considering the request for planning received from the client company and an estimated value of a request for planning from any client company with recent transaction record, and outputs the result of creating the production plan to the client company from which the request is received.

2. The system according to claim 1, wherein the planning device further includes a means activated immediately after creating the production plan or at a predetermined regular cycle for allocating a manufacturable quantity for each company according to a ratio of a number of orders placed by all companies that placed orders in a past set period, with a delivery date that is a preset period from the current date and time or a preset period from the delivery date of the latest order for each company, subtracting an already ordered number from the manufacturable quantity, and updating the planning conditions with the result.

3. The system according to claim 1, wherein, when the planning device receives the request for planning from the first client company from the service management device and creates a production plan, the planning device responds to the service management device with the created production planning result.

4. The system according to claim 2, wherein, when the planning device recalculates and updates the planning conditions of all companies that placed orders in a past set period, the planning device transmits the planning conditions related to a corresponding client company to the service management device that received the request for planning.

5. The system according to claim 3, wherein the service management device transmits the request for planning from the client company to the planning device of a corresponding contractor company, then receives a result of creating the production plan created by the planning device, and responds with the production planning result to the client company from which the request is originally received.

6. The system according to claim 4, wherein the service management device transmits the request for planning from the client company to the planning device of a corresponding contractor company, then receives the planning conditions related to the client company updated by the planning device from the planning device, and updates own planning conditions.

7. The system according to claim 1, wherein
when the request of the client company meets the planning conditions, the service management device transmits a response to accept the manufacturing request to the client company and transmits a similar response to the planning device,
the planning device reflects the response received from the service management device in the plan, recalculates and updates the planning conditions, and transmits the planning conditions related to the corresponding client company to the service management device, and
the service management device receives the planning conditions related to the client company updated by the planning device from the planning device, and updates own planning conditions and history.

8. The system according to claim 2, wherein the planning device allocates the manufacturable quantity for each company according to the ratio of the number of orders from all companies that placed orders in the past set period, then, considering the on-time delivery rate, adjusts the manufacturable quantity such that the on-time delivery rate is 100%, and finally updates the planning condition with the manufacturable quantity subtracted by the already ordered number.

9. The system according to claim 1 characterized in that the service management device is a virtual device configured on a cloud by a cloud service company, and is configured exclusively for each client company that uses the device while an actual device resides on a server of the cloud service company.

10. The system according to claim 1, wherein
on a screen by which the planning device reports the production planning results,
in the production plan for each production line, boxes are arranged in chronological order, length of each box represents time used for production of the same client, the client and a difference in number of days from a requested delivery date are displayed in each box, and shade of color of the box is changed according to planning time such that as a difference between the current time and the planning time decreases, a darker color is displayed.

11. A method for creating a production plan, characterized in that a network is connected to a service management device configured for a client company and a planning device configured for a contractor company, and
the service management device stores in advance planning conditions, which are determination values for a delivery date and a number of items for each contractor company and for each item, and whether a manufacturing request can be accepted is determined without inquiring the planning device in response to a request for planning received from the client company, the method comprising:
a process of the service management device receiving the request for planning from the client company, referring to the previously stored planning conditions, and determining whether the request of the client company meets the planning conditions;
a process of the service management device transmitting a response to accept the manufacturing request to the client company when determining that the request from the client company meets the planning conditions, and transmitting a similar response to the planning device;
a process of the planning device reflecting the response received from the service management device in the plan, recalculating and updating the planning conditions, and transmitting the planning conditions related to the corresponding client company to the service management device;
a process of the service management device receiving the planning conditions related to the client company updated by the planning device from the planning device, and updating own planning conditions and history;
a process of the service management device transmitting the request for planning of the client company to the planning device of a corresponding contractor company, when determining that the request of the client company does not meet the planning conditions;
a process of the planning device receiving the request for planning from the client company received from the service management device, creating a production plan by considering the request for planning received from the client company and an estimated value of the request for planning from another client company with recent transaction record, and responding to the service management device with the created production planning result;
a process of the planning device recalculating and updating planning conditions of all companies that placed orders in a past set period, and transmitting planning conditions related to corresponding client company to the service management device that received the request for planning;
a process of the service management device transmitting a request for planning from the client company to the planning device of the corresponding contractor company, receiving a production planning result created by the planning device, and responding with the production planning result to the client company from which the request is originally received; and
a process of the service management device transmitting the request for planning from the client company to the planning device of the corresponding contractor company, receiving the planning conditions related to the client company updated by the planning device from the planning device, and updating own planning conditions.

12. The method according to claim 11 further comprising:
a process of the planning device receiving an input created in response to a request for planning received by the contractor company from a client company that does not use the service management device, creating a production plan by considering the request for planning received from the client company and an estimated value of the request for planning from another client company with recent transaction record, and outputting the created production planning result to the client company from which the request is received;
a process of the planning device recalculating and updating the planning conditions of all companies that placed orders in a past set period, and transmitting the planning conditions related to the corresponding client company to each service management device; and
a process of each service management device receiving the planning conditions related to the client company updated by the planning device from the planning device, and updating own planning conditions and history.
